(19) United States
(12) Patent Application Publication
(10) Pub. No.: US 2008/0025418 A1
(43) Pub. Date: Jan. 31, 2008

(54) METHOD FOR CHANNEL ESTIMATION

(75) Inventors: QIN LIU, Fremont, CA (US); Dinesh Venkatachalam, Fremont, CA (US)

Correspondence Address: FRANKLIN (LIN) YANG, 91 CANTERBURY GATE, LYNBROOK, NY, 11563, US

(73) Assignee: LEGEND SILICON, Fremont, CA (US)

(21) Appl. No.: 11/550,358

(22) Filed: Oct. 17, 2006

Related U.S. Application Data
(60) Provisional application No. 60/820,319, filed on Jul. 25, 2006.

(51) Int. Cl. H04K 1/10; H04L 27/06

(52) U.S. Cl. 375/260; 375/340

(57) ABSTRACT

A channel estimation using the received PN (pseudo-noise) sequence associated with a received frame among a plurality of associated, neighboring frames. The estimation using a value associated with a point of a currently frame as a denominator in a predetermined formula. If the value is smaller than its corresponding value in a neighboring frame, the neighboring frame's corresponding value is used instead of the value of the current frame.

### REFERENCE TO RELATED APPLICATIONS

This application claims an invention which was disclosed in Provisional Application No. 60/820,319, filed Jul. 25, 2006 entitled “Receiver For An LDPC based TDS-OFDM Communication System”. The benefit under 35 USC §119(e) of the United States provisional application is hereby claimed, and the aforementioned application is hereby incorporated herein by reference.

### FIELD OF THE INVENTION

The present invention related generally to communication devices. More specifically, the present invention related to channel in an OFDM (Orthogonal frequency-division multiplexing) device.

### BACKGROUND

OFDM (Orthogonal frequency-division multiplexing) is known. U.S. Pat. No. 3,488,445 to Chang describes an apparatus and method for frequency multiplexing of a plurality of data signals simultaneously on a plurality of mutually orthogonal carrier waves such that overlapping, but band-limited, frequency spectra are produced without causing interchannel and intersymbol interference. Amplitude and phase characteristics of narrow-band filters are specified for each channel in terms of their symmetries alone. The same signal protection against channel noise is provided as though the signals in each channel were transmitted through an independent medium and intersymbol interference were eliminated by reducing the data rate. As the number of channels is increased, the overall data rate approaches the theoretical maximum.

OFDM transreceivers are known. U.S. Pat. No. 5,282,222 to Fattouche et al described a method for allowing a number of wireless transceivers to exchange information (data, voice or video) with each other. A first frame of information is multiplexed over a number of wideband frequency bands at a first transceiver, and the information transmitted to a second transceiver. The information is received and processed at the second transceiver. The information is differentially encoded using phase shift keying. In addition, after a pre-selected time interval, the first transceiver may transmit again. During the preselected time interval, the second transceiver may exchange information with another transceiver in a time duplex fashion. The processing of the signal at the second transceiver may include estimating the phase differential of the transmitted signal and pre-distorting the transmitted signal. A transceiver includes an encoder for encoding information, a wideband frequency division multiplexer for multiplexing the information onto wideband frequency voice channels, and a local oscillator for upconverting the multiplexed information. The apparatus may include a processor for applying a Fourier transform to the multiplexed information to bring the information into the time domain for transmission.

Using PN (pseudo-noise) as the guard interval in an OFDM is known. U.S. Pat. No. 7,072,289 to Yang et al describes a method for estimating timing of at least one of the beginning and the end of a transmitted signal segment in the presence of time delay in a signal transmission channel. Each of a sequence of signal frames is provided with a pseudo-noise (PN) m-sequences, where the PN sequences satisfy selected orthogonality and closures relations. A convolution signal is formed between a received signal and the sequence of PN segments and is subtracted from the received signal to identify the beginning and/or end of a PN segment within the received signal. PN sequences are used for timing recovery, for carrier frequency recovery, for estimation of transmission channel characteristics, for synchronization of received signal frames, and as a replacement for guard intervals in an OFDM context.

As can be seen, although PN possess some desirable qualities such as channel estimation, its associated value may fluctuate due to other factors. This is especially true upon receiving same after transmission. Therefore, it is desirous to have an improved channel estimation using the characteristics of the PN sequence for correcting same.

### SUMMARY OF THE INVENTION

A channel estimation having guard interval comprising PN (pseudo-noise) and using received PN (pseudo-noise) sequence is provided.

A channel estimation using the received PN (pseudo-noise) sequence as a guard interval and the associated time domain and frequency domain parameters is provided.

A channel estimation using the received PN (pseudo-noise) sequence as a guard interval and the associated time domain truncation and an inherent frequency domain characteristic is provided.

A channel estimation using the received PN (pseudo-noise) sequence, which represents multiple delays and attenuations, a point in a frame is not used for processing if said point has a value that is smaller than the corresponding point value of a neighboring frame. The corresponding point value of a neighboring frame is used instead.

A channel estimation using the received PN (pseudo-noise) sequence associated with a received frame among a plurality of associated, neighboring frames. The estimation using a value associated with a point of a currently frame as a denominator in a predetermined formula. If the value is smaller than its corresponding value in a neighboring frame, the neighboring frame's corresponding value is used instead of the value of the current frame.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a receiver in accordance with some embodiments of the invention.

FIG. 2 is an example of part of a received symbol.

FIG. 3 is a first example of frequency characteristics of PN.

FIG. 4 is a second example of frequency characteristics of PN.

FIG. 5 is an exemplified flowchart of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to estimate a channel based upon changing a value of a PN point within a frame for computation to a corresponding value in a neighboring frame. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of estimation of a channel based upon changing a value of a PN point within a frame for computation to a corresponding value in a neighboring frame described herein. The non-processor circuits may include, but are not limited to, a radio receiver, a radio transmitter, signal drivers, clock circuits, power source circuits, and user input devices. As such, these functions may be interpreted as steps of a method to perform estimating a channel based upon changing a value of a PN point within a frame for computation to a corresponding value in a neighboring frame. Alternatively, some or all functions could be implemented by a state machine that has not stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles described herein will be readily capable of generating such software instructions and programs and ICs with minimal experimentation.

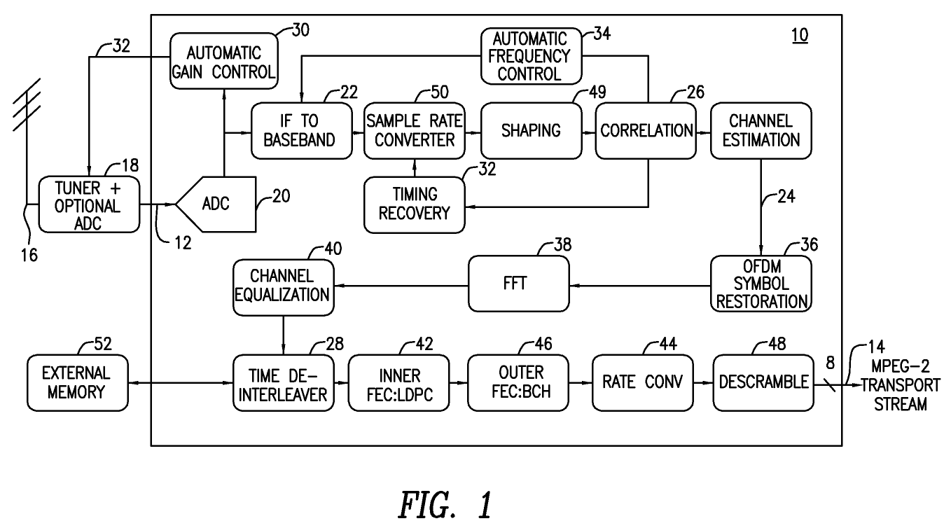

Referring to FIG. 1, a receiver 10 for implementing a LDPC based TDS-OFDM communication system is shown. In other words, FIG. 1 is a block diagram illustrating the functional blocks of an LDPC based TDS-OFDM receiver 10. Demodulation herein follows the principles of TDS-OFDM modulation scheme. Error correction mechanism is based on LDPC. The primary objectives of the receiver 10 is to determine from a noise-perturbed system, which of the finite set of waveforms have been sent by a transmitter and using an assortment of signal processing techniques reproduce the finite set of discrete messages sent by the transmitter.

The block diagram of FIG. 1 illustrates the signals and key processing steps of the receiver 10. It is assumed the input signal 12 to the receiver 10 is a down-converted digital signal. The output signal 14 of receiver 10 is a MPEG-2 transport stream. More specifically, the RF (radio frequency) input signals 16 are received by an RF tuner 18 where the RF input signals are converted to low-IF (intermediate frequency) or zero-IF signals 12. The low-IF or zero-IF signals 12 are provided to the receiver 10 as analog signals or as digital signals (through an optional analog-to-digital converter 20). A shaping block 54 is provided for shaping the signals suitable for further processing.

In the receiver 10, the IF (intermediate frequency) signals are converted to base-band signals 22. TDS-OFDM (Time domain synchronous-Orthogonal frequency-division multiplexing) demodulation is then performed according to the parameters of the LDPC (low-density parity-check) based TDS-OFDM modulation scheme. The output of the channel estimation 24 and correlation block 26 is sent to a time de-interleaver 28 and then to the forward error correction block. The output signal 14 of the receiver 10 is a parallel or serial MPEG-2 transport stream including valid data, synchronization and clock signals. The configuration parameters of the receiver 10 can be detected or automatically programmed, or manually set. The main configurable parameters for the receiver 10 include: (1) Sub carrier modulation type: QPSK, 16QAM, 64QAM; (2) FEC (forward error correction) rate: 0.4, 0.6 and 0.8; (3) Guard interval: 420 or 945 symbols; (4) Time de-interleaver mode: 0, 240 or 720 symbols; (5) Control frames detection; and (6) Channel bandwidth: 6, 7, or 8 MHz.

The functional blocks of the receiver 10 are described as follows.

Automatic gain control (AGC) block 30 compares the input digitized signal strength with a reference. The difference is filtered and the filter value 32 is used to control the gain of the amplifier 18. The analog signal provided by the tuner 12 is sampled by an ADC 20. The resulting signal is centered at a lower IF. For example, sampling a 36 MHz IF signal at 30.4 MHz results in the signal centered at 5.6 MHz. The IF to Baseband block 22 converts the lower IF signal to a complex signal in the baseband. The ADC 20 uses a fixed sampling rate. Conversion from this fixed sampling rate to the OFDM sample rate is achieved using the interpolator in block 22. The timing recovery block 32 computers the timing error and filters the error to drive a Numerically Controlled Oscillator (not shown) that controls the sample timing correction applied in the interpolator of the sample rate converter.

There can be frequency offsets in the input signal 12. The automatic frequency control block 34 calculates the offsets and adjusts the IF to baseband reference IF frequency. To improve capture range and tracking performance, frequency control is done in two stages: coarse and fine. Since the transmitted signal is square root raised cosine filtered, the received signal will be applied with the same function. It is known that signals in a TDS-OFDM system include a PN sequence preceding the IDFT (inverse discrete Fourier transform) symbol. By correlating the locally generated PN with the incoming signal, it is easy to find the correlation peak (so the frame start can be determined) and other synchronization information such as frequency offset and timing error. Channel time domain response is based on the signal correlation previously obtained. Frequency response is taking the FFT of the time domain response.

In TDS-OFDM, a PN sequence replaces the traditional cyclic prefix. It is thus necessary to remove the PN sequence and restore the channel spreaded OFDM symbol. Block 36 reconstructs the conventional OFDM symbol that can be one-tap equalized. The FFT block 38 performs a 3780 point FFT. Channel equalization 40 is carried out to the FFT 38 transformed data based on the frequency response of the channel. De-rotated data and the channel state information are sent to FEC for further processing.

In the TDS-OFDM receiver 10, the time-deinterleaver 28 is used to increase the resilience to spurious noise. The time-deinterleaver 28 is a convolutional de-interleaver which needs a memory with size B*(B−1)*M/2, where B is the number of the branch, and M is the depth. For the TDS-OFDM receiver 10 of the present embodiment, there are two modes of time-deinterleaving. For mode 1, B=52, M=240, and for mode 2, B=52, M=720.

The LDPC decoder 42 is a soft-decision iterative decoder for decoding, for example, a Quasi-Cyclic Low Density Parity Check (QC-LDPC) code provided by a transmitter (not shown). The LDPC decoder 42 is configured to decode at 3 different rates (i.e. rate 0.4, rate 0.6 and rate 0.8) of QC_LDPC codes by sharing the same piece of hardware. The iteration process is either stopped when it reaches the specified maximum iteration number (full iteration), or when the detected error is free during error detecting and correcting process (partial iteration).

The TDS-OFDM modulation/demodulation system is a multi-rate system based on multiple modulation schemes (QPSK, 16QAM, 64QAM), and multiple coding rates (0.4, 0.6, and 0.8), where QPSK stands for Quad Phase and QAM stands for Quadrature Amplitude Modulation. The output of BCH decoder is bit by bit. According to different modulation scheme and coding rates, the rate conversion block combines the bit output of BCH decoder to bytes, and adjusts the speed of byte output clock to make the receiver 10's MPEG packets outputs evenly distributed during the whole demodulation/decoding process.

The BCH decoder 46 is designed to decode BCH (762, 752) code, which is the shortened binary BCH code of BCH (1023, 1013). The generator polynomial is x̂10+x̂3+1.

Since the data in the transmitter has been randomized using a pseudo-random (PN) sequence before BCH encoder (not shown), the error corrected data by the LDPC/BCH decoder 46 must be de-randomized. The PN sequence is generated by the polynomial 1+x¹⁴+x¹⁵, with initial condition of 100101010000000. The de-scrambler/de-randomizer 48 will be reset to the initial condition for every signal frame. Otherwise, de-scrambler/de-randomizer 48 will be free running until reset again. The least significant 8-bit will be XORed with the input byte stream.

The data flow through the various blocks of the modulator is as follows. The received RF information 16 is processed by a digital terrestrial tuner 18 which picks the frequency bandwidth of choice to be demodulated and then downconverts the signal 16 to a baseband or low-intermediate frequency. This downconverts information 12 is then converted to the Digital domain through an analog-to-digital data converter 20.

The baseband signal after processing by a sample rate converter 50 is converted to symbols. The PN information found in the guard interval is extracted and correlated with a local PN generator to find the time domain impulse response. The FFT of the time domain impulse response gives the estimated channel response. The correlation 26 is also used for the timing recovery 32 and the frequency estimation and correction of the received signal. The OFDM symbol information in the received data is extracted and passed through a 3780 FFT 38 to obtain the symbol information back in the frequency domain. Using the estimated channel estimation previously obtained, the OFDM symbol is equalized and passed to the FEC decoder.

At the FEC decoder, the time-deinterleaver block 28 performs a deconvolution of the transmitted symbol sequence and passes the 3780 blocks to the inner LDPC decoder 42. The LDPC decoder 42 and BCH decoders 46 which run in a serial manner take in exactly 3780 symbols, remove the 36 TPS symbols and process the remaining 3744 symbols and recover the transmitted transport stream information. The rate conversion 44 adjusts the output data rate and the de-randomizer 48 reconstructs the transmitted stream information. An external memory 52 coupled to the receiver 10 provides memory thereto on a predetermined or as needed basis.

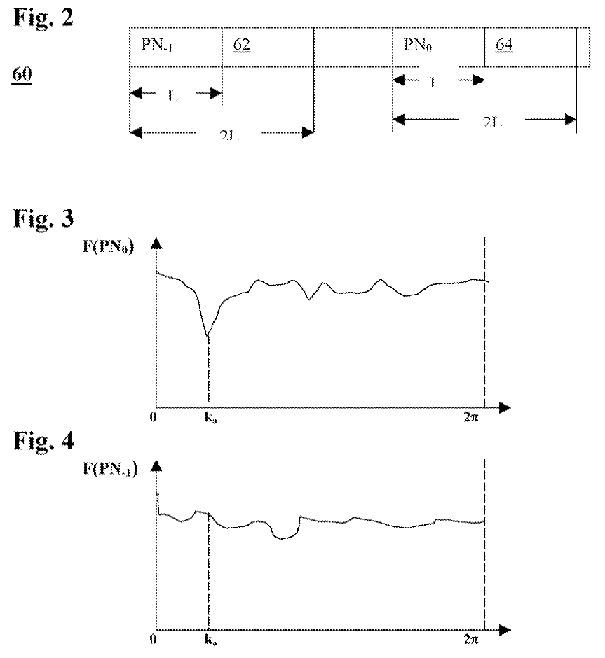

Referring to FIGS. 2-4, part of a received TDS-OFDM, time-domain PN sequence placed within a symbol 60 is shown. PN sequence are inserted as guard intervals between consecutive IDFT (inverse discrete Fourier transform) blocks. The received PN sequence is effected by the summation of multiple delays, attenuations based on channel profile, and interference form previous and present OFDM. It is presumed that parameters of the system are all suitable for the implementation of the present invention. These parameters comprise established synchronization, fixed length L for the received PN, and the earliest PN start position, etc. Furthermore, channel delay is restricted to length 2L received symbol portion Y is defined on length 2L including the PN length of L, i.e. Y_{2L}. Therefore, the symbol portion of Y₋₁ is 62, and of Y₁ is 64. Under the above conditions, the channel delay response is expressed as:

H=FFT(Y)/FFT(PN) (1)

For the above formula, both of the FFT are of same length, and the length of computation is larger than 2L. To revert back to time domain, a IFFT or FFT⁻¹ may be performed. In other words, f(n)=F⁻¹[H(k)] within a desired area of segment.

An inordinately large value of H is undesirable because PN is presumed to have characteristics not similar to white noise, wherein the same has a flat spectrum. Therefore, any large value of H reflects inaccuracies due to such things as transmission distortion such as the effects of the summation of multiple delays, attenuations based on channel profile, and interference form previous and present OFDM. Or alternatively due to the inherent nature of PN, it is known that at certain point of interest (or computation) of FFT(PN), the fast Fourier Transform may yield a small value such that the H of formula may yield an inordinately large value. For example, at point kₐ the curve F(PN₁) has is deep in that the value of F(PN₁) is relatively small compared with other points of curve F(PN₁). Presuming there is a threshold value that the system can live with, and the above relatively small value is smaller than said threshold value; the present invention discloses a method or system for addressing same. The present invention takes into consideration that fact that in a TDS-OFDM system PN sequence is different in neighboring frames. Note that repetition only happens every super frame, for example, every 225 frames in the PN420 mode.

As shown in FIGS. 3-4, because the existence of the dip in F(PN₀) value at point kₐ as shown in FIG. 3, the F(PN₋₁) value in FIG. 4 at point kₐ is used instead. In other words, the H₀ of formula (1) is replaced at a point of a previous H₋₁ at the same corresponding point. Given the condition the FFT(PN), the denominator of equation (1) has a larger value than the present value of FFT(PN). This way frequency composition is so defined. Similarly, in the time domain truncation occurs in that the response of Channel (IFFT of H) is limit by length L, i.e. guard length. The first derivative H′(k)=F(h(n)).

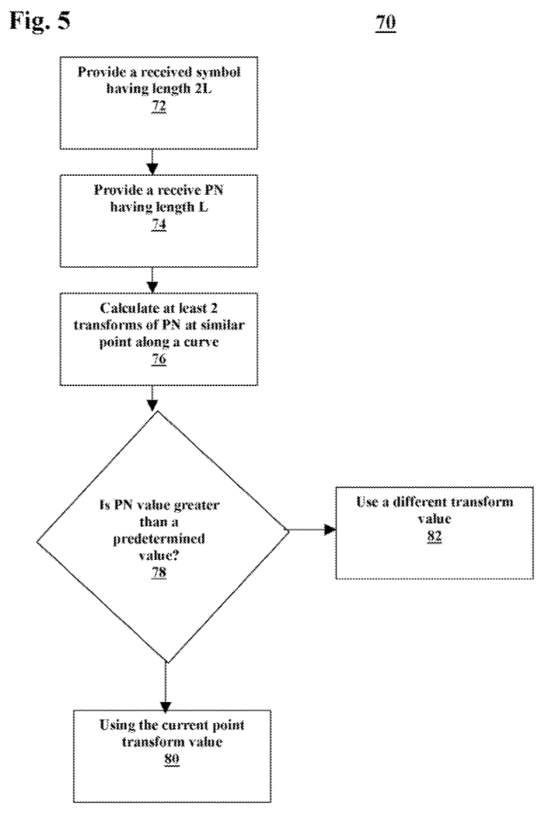

Referring to FIG. 5, a flow chart 70 is shown. The frequency estimation can be defiled as

$$H ( k ) = \{ \begin{matrix}{H}_{… 1} ( k ) … F ( {PN}_{… 1} ) > Threshold \& F ( {PN}_{0} ) < Threshold \\ {H}_{0} ( k ) … otherwise\end{matrix}$$

Note that the threshold is a predetermined values among H(PN). Received symbol Y is defined as part of the symbol including the corresponding PN having length 2L. Therefore: H₋₁(k)=F(Y_{2L-1})/F(PN)₋₁ and H₁(k)=F(Y_{2L1})/F(PN)₀

As can be seen, the time domain of H(k) is defined as:

$$h ( n ) = \{ \begin{matrix}{F}^{- 1} [ H ( k ) ] … n \leq L \\ 0 … n > L\end{matrix}$$

Going back to Flowchart 70, a received symbol having length 2L is provided (Step 72). Furthermore, a reference PN having length L is provided (Step 74). At least two transforms of PN is performed (Step 76), wherein one PN may be the current transformed value, and the other be the at least one PN reference. Although there may be other references, only one reference is described herein for the sake of simplicity. In turn, a determination step is performed herein (Step 78), wherein a comparing action is performed in that if the transformed value is greater than a predetermined threshold value, said value is used for the computation of equation (1). On the other hand, if the transformed value is less than the predetermined threshold value, said value is not used for the computation of equation (1) but the reference is used instead.

It is noted that the present invention contemplates using the PN sequence disclosed in U.S. Pat. No. 7,072,289 Yang et al which is hereby incorporated herein by reference.

A receiver in an OFDM (Orthogonal frequency-division multiplexing) communication system is provided. The receiver a method for channel estimation is provided. The method includes the steps of: receiving a PN (pseudo-noise) sequence; and using a selected value comprising a neighboring frame's corresponding value for a computation associated with a current frame if the current frame has a value that is less than the corresponding value, whereby the channel estimation is improved therefore.

A method in an OFDM (Orthogonal frequency-division multiplexing) communication system is provided. The method includes the steps of: receiving a PN (pseudo-noise) sequence; and using a selected value comprising a neighboring frame's corresponding value for a computation associated with a current frame if the current frame has a value that is less than the corresponding value, whereby the channel estimation is improved therefore.

In the foregoing specification, specific embodiments of the present invention have been described. However, one of ordinary skill in the art appreciates that various modifications and changes can be made without depending from the scope of the present invention as set forth in the claims below. Accordingly, the specification and figures are to be regarded in an illustrative rather than a restrictive sense, and all such modifications are intended to be included with the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely be the appended claims including any amendments made during the pendency of this application and all equivalents of those claims as issued.

What is claimed is:

1. In an OFDM (Orthogonal frequency-division multiplexing) communication system, a method for channel estimation comprising the steps of:
receiving a PN (pseudo-noise) sequence; and
using a selected value comprising a neighboring frame's corresponding value for a computation associated with a current frame if the current frame has a value that is less than the corresponding value, whereby the channel estimation is improved therefore.

2. The method of claim 1 further comprising the value of the PN (pseudo-noise) sequence of the present frame with a corresponding value of the neighboring frame.

3. The method of claim 1, wherein the selected value comprises the greater value among a plurality of values each representing a predetermined point within the plurality of correspondingly, neighboring frames to the current frame.

4. The method of claim 1, wherein the value is a Fourier transform value of a specific frequency in the frequency domain.

5. The method of claim 1, wherein a synchronization is achieved.

6. The method of claim 1, wherein a starting position being the earliest in a predetermined time interval is known.

7. The method of claim 1, wherein the PN sequence is used as guard intervals between transmitted data.

8. The method of claim 1, wherein the PN sequence comprises a predetermined unit length.

9. The method of claim 1, wherein the length of the transformed symbol is defined on twice the length of the PN sequence.

10. In an OFDM (Orthogonal frequency-division multiplexing) communication system, a receiver comprising:
method for channel estimation comprising the steps of:
receiving a PN (pseudo-noise) sequence; and
using a selected value comprising a neighboring frame's corresponding value for a computation associated with a current frame if the current frame has a value that is less than the corresponding value, whereby the channel estimation is improved therefore.

12. The receiver of claim 10, wherein the method further comprising comparing the value of the PN (pseudo-noise) sequence of the present frame with a corresponding value of the neighboring frame.

13. The receiver of claim 10, wherein the selected value comprises the greater value among a plurality of values each representing a predetermined point within a plurality of correspondingly, neighboring frames to the current frame.

14. The method of claim 10, wherein the value is a Fourier transform value of a specific frequency in the frequency domain.

15. The method of claim 10, wherein a synchronization is achieved.

16. The method of claim 10, wherein a starting position being the earliest in a predetermined time interval is known.

17. The method of claim 10, wherein the PN sequence is used as guard intervals between transmitted data.

18. The method of claim 10, wherein the PN sequence comprises a predetermined unit length.

19. The method of claim 10, wherein the length of the transformed symbol is defined on twice the length of the PN sequence.
